(19) United States
(12) Patent Application Publication
(10) Pub. No.: US 2015/0128206 A1
(43) Pub. Date: May 7, 2015

(54) Early Filtering of Events Using a Kernel-Based Filter

(71) Applicant: TRUSTEER LTD., Tel Aviv (IL)

(72) Inventors: Eldan Ben Haim, Kiryat Ono (IL); Ilan Fraiman, Tel Aviv (IL); Arkady Dubovsky, Shaarey Tiqwa (IL)

(73) Assignee: TRUSTEER LTD., Tel Aviv (IL)

(21) Appl. No.: 14/071,426

(22) Filed: Nov. 4, 2013

(51) Int. Cl. G06F 21/52

(52) U.S. Cl. CPC G06F 21/52
USPC 726/1

(57) ABSTRACT

A method for providing early filtering of events using a kernel-based filter, comprising the steps of: a) providing a driver for the kernel level that acts as a kernel filtering process, wherein said driver is configured to match events that occur at the kernel level according to predefined rules; and b) upon finding a match, acting according to the definition of the matched rule in order to allow the event, disallow said event or forward the content of said event for further processing.

### FIELD OF THE DISCLOSURE

The present disclosure relates to the field of computer security. More particularly, the exemplary embodiment relates to a method for the early filtering of events using a kernel-based filter mechanism.

### BACKGROUND OF THE DISCLOSURE

As more users are connected to the Internet and conduct their daily activities electronically, computer users have become the target of an underground economy that infects hosts with malware (e.g., for financial gain). For example, a single visit to an infected web site enables an attacker to detect vulnerabilities in the user's applications and force the download of malware binaries. Frequently, this malware allows the adversary to gain full control of the compromised systems leading to the ex-filtration of sensitive information or installation of utilities that facilitate remote control of the host.

In the prior art, malware detection services/processes process data at the user level of each suspicious events delivered from the kernel level. However, major drawbacks of processing in the user level include time consumption and the computing resources required for such processing.

It is an object of the present disclosure to provide a system which is capable of selectively sending suspicious events from the kernel level to the user level for further processing, and thereby reducing time and computing consumptions.

Other objects and advantages will become apparent as the description proceeds.

### SUMMARY OF THE DISCLOSURE

The present disclosure relates to a method for providing early filtering of events using a kernel-based filter, comprising the steps of: a) providing a driver for the kernel level that acts as a kernel filtering process, wherein said driver is adapted to match events that occur at the kernel level according to predefined rules; and b) upon finding a match, acting according to the definition of the matched rule in order to allow the event, disallow said event or forward the content of said event for further processing.

According to an embodiment, the matching with rules is done in a prioritized manner.

According to an embodiment, the method further comprises an application/service that runs in the user level for performing the further processing of the forward events.

According to an embodiment, the rules are defined according to expected behavior of events at the kernel level, wherein said expected behavior may indicate the nature of legitimate or malicious programs.

According to an embodiment, each predefined rule defines whether to allow an event, disallow the event or to forward the event for further processing in the user level.

An exemplary embodiment also encompasses a system for early filtering of events using a kernel-based filter, the system comprising: a memory; and at least one processor configured to interface with the memory and to execute a kernel filtering process in a kernel for events executed in the kernel level; provide a driver that is adapted to match events that occur at the kernel with one or more rules, and upon finding a match to act according to the definition of the matched rule in order to allow the event, disallow said event or forward the content of said event for further processing in the user level.

An exemplary embodiment also encompasses relates to a computer readable storage medium on which is embedded one or more computer programs, said one or more computer programs implementing a method of providing early filtering of events using a kernel-based filter, said one or more computer programs comprising a set of instructions for: filtering events executed in the kernel level according to predefined rules, wherein each rule defines whether to allow an event, disallow the event or to forward said event for further processing in the user level; and providing a driver for the kernel level that acts as a kernel filtering process, wherein said driver is adapted to match events that occur at the kernel level with one or more of rules and upon finding a match acting according to the definition of the matched rule in order to allow the event, disallow said event or forward the content of said event for further processing.

### BRIEF DESCRIPTION OF THE DRAWINGS

In the drawings:

FIG. 1 is a block diagram generally illustrating a computing operating environment for an exemplary embodiment.

### DETAILED DESCRIPTION

Throughout this description the term “event” is used to indicate an attempt to perform an operation or task in a computing operating environment such as an attempt to write to a hard disk, an attempt to write to the registry, an attempt to execute another process, etc. This term does not imply any particular operation system, and various embodiments are applicable to all suitable operation systems.

In the following detailed description references are made to the accompanying drawings that form a part hereof, and in which shown by way of illustration specific embodiments or examples. These embodiments may be combined, other embodiments may be utilized, and structural changes may be made without departing from the spirit or the scope of the disclosure. The following detailed description is therefore not to be taken in a limiting sense and the scope of the present disclosure is defined by the appended claims and their equivalents.

Embodiments generally relate to a method and system for filtering events in the kernel. More particularly, a kernel filtering process operating in kernel space may be configured to allow/disallow selected events at the kernel level and to forward events (e.g., which the filter is unable to allow/disallow) for further processing by a dedicated component in the user space (i.e., an application or service at the user level, so called level 2). The kernel filtering process can be implemented as a kernel code in form of a driver that runs in the kernel.

According to an embodiment, the kernel filtering process may examine each event (or only selected events) in the kernel space. For example, the filtering process may compare the information of the examined event with one or more criteria expected to be matched with respect to a list of one or more rules. A match may indicate (to the kernel filtering process) to decide whether to disallow or allow the event. Accordingly, the kernel filtering process may determine whether an event is relevant for the respective application based on the comparison.

The kernel filtering process reduces the flow of traffic passing from the kernel to the service at the user space by disallowing/allowing events directly within the kernel level. The term “disallow” may refer to a task such as blocking the examined event, while the term “allow” means that the examined event can be completed. Only events that the filtering process is incapable of deciding whether to disallow or allow (or specific events that were previously defined as such) are forwarded to an application/service in the user space (i.e., level 2).

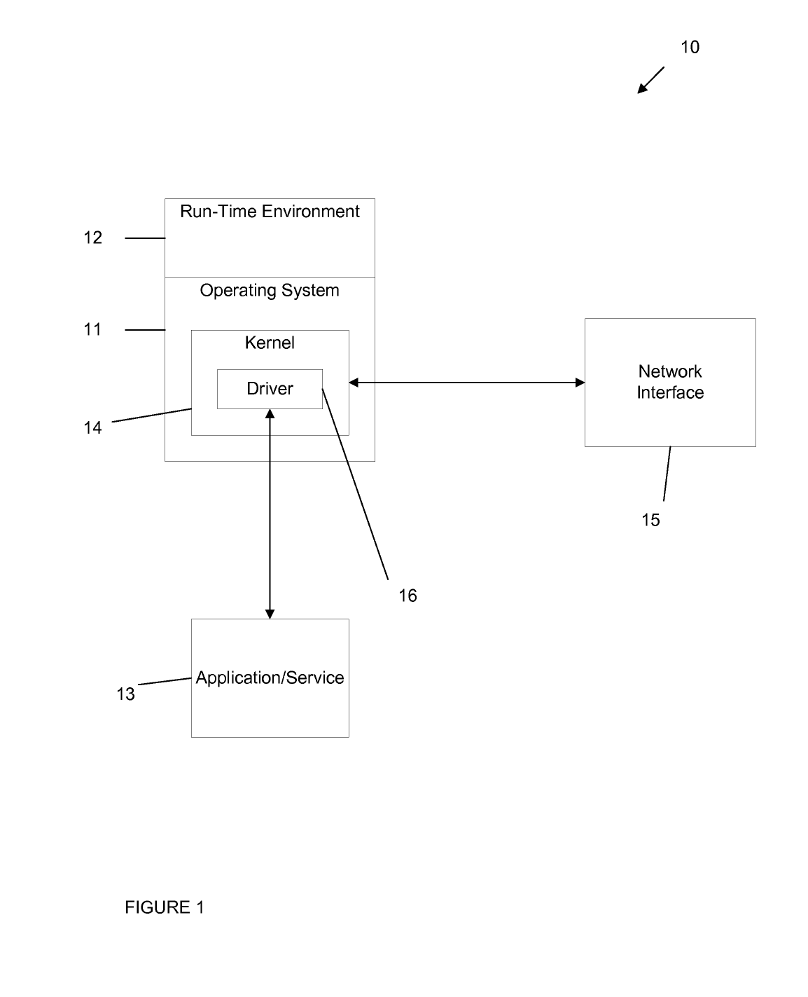

Referring now to FIG. 1, in which aspects of an exemplary computing operating environment will be described, the following discussion is intended to provide a brief, general description of a suitable computing environment in which the various embodiments may be implemented. While embodiments will be described in the general context of program modules that execute in conjunction with an application program that runs on an operating system on a personal computer, those skilled in the art will recognize that various embodiments may also be implemented in combination with other program modules.

FIG. 1 illustrates a software environment 10 in accordance with an exemplary embodiment. It should be readily apparent to those of ordinary skill in the art that the software environment 10 illustrated in FIG. 1 represents a generalized schematic illustration and that other components may be added or existing components may be removed or modified.

As shown in FIG. 1, the software environment 10 may include an operating system 11. The operating system 11 may be a version of a MS Windows or other operating system such as Linux or UNIX. A run-time environment 12 may be configured to execute on the operating system 11. The run-time environment 12 may provide a set of software agents that supports the execution of applications and programs. The run-time environment 12 may include an Application Program Interface (API). The APIs may be configured to provide a set of routines that an application 13 uses to request lower-level services performed by the operating system 11. The operating system 11 may include a kernel 14. The kernel 14 may be configured to provide secure access to the underlying hardware of a processor. The kernel 14 may also be configured to interface with the network interface 15 for access to the network.

Moreover, the network interface may perform transmission and reception of information by means of various networks. Networks as described herein may include various communication networks, but are not limited to: a wireless network, a wired network or any combination of wireless network and wired network. For example, networks may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, networks may include, without limitation, telephone line, fiber optics, IEEE Ethernet 802.3, a wide area network (“WAN”), a local area network (“LAN”), or a global network such as the Internet.

In some embodiments, the kernel 14 may execute a kernel processing filtering process 16. As previously described, the kernel processing filtering process (e.g., as indicated by driver 16) may be configured to filter events at the kernel level as compared with conventional system that passes the events to the application level (i.e., the user space) for further processing. As a result, the work the operating system has to process the event's data for application level filtering is reduced to only the relevant events.

Generally, program modules include routines, programs, components, data structures, and other types of structures that perform particular tasks. Moreover, those skilled in the art will appreciate that the some embodiments may be executed by computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

For example, computer system configurations described herein for executing embodiments of the kernel filtering process may include, but are not limited to: e.g., any computer, a personal computer, a laptop, a cellular communication device, a workstation, a mobile device, a phone, a handheld PC, a personal digital assistant (“PDA”), a thin system, a fat system, a network appliance, an Internet browser, or other any other device that may allow a user to communicate via a communication network.

It is to be appreciated that the set of instructions, e.g., computer programs, software environment, and program modules, that configures the kernel and computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other non-transitory medium or source of data that may be read by a computer.

As will be appreciated by the skilled person the embodiments described hereinabove result in a two-layered system that runs a first coarse grained filter at the kernel level, and only sends selected events to the user space for further processing. This significantly reduces time consumption as the further processing at the user level will apply to reduced number of events with respect to prior art malware detection services/process.

All the above will be better understood through the following illustrative and non-limitative examples.

An exemplary rule for forwarding an event to layer 2 (user level) for further processing can be set as follows:
If an event associated with the execution of a “create process” that is path refers to the “temporary folder” of the system, then forward the event to layer 2 for a further processing.

There are malwares with filename identical to a known program, e.g., a malware filename can be called under the name of a popular browser such as “firefox.exe”. An exemplary set of simple prioritized rules for allowing/denying an event in layer 1 (i.e., in the kernel level) for such case can be set as follows:
Rule no. 1: if an event performs an operation such as “create process” under the legitimate or default path of a known program, then the kernel filtering process will allow the task. For example, in MS-Windows OS the default path of Firefox browser is usually set as follows: “C:\Program Files\Mozilla Firefox\firefox.exe”
Rule no. 2: if an event performs an operation such as “create process” under any other path (e.g., “*\firefox.exe”), then the kernel filtering process will disallow the execution of that process. For example, in MS-Windows OS the path of the suspicious event “firefox.exe” leads to the path: “C:\temp\firefox.exe”.

In this example, the kernel filtering process goes through the rules according to their order of appearance, such that it will first match the event content with the first rule (rule no. 1), and only if there is no match, then it will continue to match the event with the second rule (rule no. 2). However, the list may include rules without priority or dependency on other rules. These examples of simple rules are used for the purpose of illustration only. A person skilled in the art will appreciate that more sophisticated rules can be used.

All the above description and examples have been given for the purpose of illustration and are not intended to limit the disclosure in any way. Many different mechanisms, methods of analysis, electronic and logical elements can be employed, all without exceeding the scope of the disclosure.

We claim:

1. A method for providing early filtering of events using a kernel-based filter, comprising the steps of:
a) providing a driver for the kernel level that acts as a kernel filtering process, wherein said driver is adapted to match events that occur at the kernel level according to predefined rules; and
b) upon finding a match, acting according to the definition of the matched rule in order to allow the event, disallow said event or forward the content of said event for further processing.

2. A method according to claim 1, wherein the matching with rules is done in a prioritized manner.

3. A method according to claim 1, further comprising a service/process that runs in the user level for performing the deeper processing of the forward events.

4. A method according to claim 1, wherein the rules are defined according to expected behavior of events at the kernel level, wherein said expected behavior may indicate the nature of legitimate or malicious programs.

5. A method according to claim 1, wherein each predefined rule defines whether to allow an event, disallow the event or to forward the event for deeper processing in the user level.

6. A system for early filtering of events using a kernel-based filter, the system comprising: a memory; and at least one processor configured to interface with the memory and to execute a kernel filtering process in a kernel for events executed in the kernel level;
provide a driver that is adapted to match events that occur at the kernel with one or more rules, and upon finding a match to act according to the definition of the matched rule in order to allow the event, disallow said event or forward the content of said event for further processing in the user level.

7. A computer readable storage medium on which is embedded one or more computer programs, said one or more computer programs implementing a method of providing early filtering of events using a kernel-based filter, said one or more computer programs comprising a set of instructions for: filtering events executed in the kernel level according to predefined rules, wherein each rule defines whether to allow an event, disallow the event or to forward said event for deeper processing in the user level; and providing a driver for the kernel level that acts as a kernel filtering process, wherein said driver is adapted to match events that occur at the kernel level with one or more of rules and upon finding a match acting according to the definition of the matched rule in order to allow the event, disallow said event or forward the content of said event for further processing.
